(19) United States
(12) Patent Application Publication
(10) Pub. No.: US 2015/0186004 A1
(43) Pub. Date: Jul. 2, 2015

(54) MULTIMODE GESTURE PROCESSING

(71) Applicant: David R. Gordon, Shibuya-ku (JP)

(72) Inventor: David R. Gordon, Shibuya-ku (JP)

(73) Assignee: GOOGLE INC., Mountain View, CA (US)

(21) Appl. No.: 13/588,454

(22) Filed: Aug. 17, 2012

(51) Int. Cl. G06F 3/0488

(52) U.S. Cl. CPC G06F 3/0488; G06F 2203/04104

(57) ABSTRACT

User input is processes on a computing device having one or more processors, a display device, and a multi-contact motion sensor interface configured to simultaneously detect contact at a plurality of points. In a multi-contact input mode, an image manipulation function is applied to an image displayed on the display device in response to detecting a multi-contact gesture. A transition from the multi-contact input mode to a single-contact input mode is executed in response to detecting a single-contact mode activation sequence including one or more events. In the second input mode, the image manipulation function is applied to the image in response to detecting a single-contact gesture.

### FIELD OF THE DISCLOSURE

The present disclosure relates to processing user input on a computing device and, more particularly, to processing gesture-based user input in multiple input modes.

### BACKGROUND

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

Today, many devices are equipped with a touchscreen via which users provide input to various applications. A user now can manipulate objects displayed on the touchscreen using her fingers or a stylus rather a keyboard, a mouse, or another input device. Moreover, a device equipped with a so-called multi-touch interface can process user interaction with multiple points on the touchscreen at the same time.

A particular input pattern including such events as, for example, a contact with the touchscreen and a certain motion of a finger or several fingers over the surface of the touchscreen typically is referred to as a gesture. A gesture can correspond to a selection of, or input to, a certain command or function. For example, a trivial gesture may be a tap on a button displayed on the touchscreen, whereas a more complex gesture may involve rotating an image or a portion of the image by placing two fingers on the touchscreen and moving the fingers along a certain path.

In general, a wide variety of software applications can receive gesture-based input. For example, such electronic devices as smart phones, car navigation systems, and hand-held Global Positioning System (GPS) units can support software applications that display interactive digital maps of geographic regions. Depending on the application and/or user preferences, a digital map may illustrate topographical data, street data, urban transit information, traffic data, etc. In an interactive mode, the user may interact with the digital map using finger gestures.

### SUMMARY

One embodiment of the techniques discussed below is a method for processing user input on a computing device having a display device and a motion sensor interface. The method includes providing an interactive digital map via the display device, processing input received via the motion sensor interface in a first input mode, detecting a mode transition event, and subsequently processing input received via the motion sensor interface in a second input mode. Processing input in the first input mode includes invoking a map manipulation function in response to detecting an instance of a multi-contact gesture. Processing input in the second input mode includes invoking the map manipulation function in response to detecting an instance of a single-contact gesture.

Another embodiment of these techniques is a method for processing user input on a computing device having a touchscreen. The method includes providing an interactive digital map via the touchscreen, processing input in a multi-touch mode, detecting a single-touch mode activation sequence including one or more touchscreen events, subsequently processing input in a single-touch mode, and automatically reverting to the multi-touch mode upon the processing of input in the single-touch mode. Processing input in the multi-touch mode includes detecting a multi-touch gesture that includes simultaneous contact with multiple points on the touchscreen. Processing input in the single-touch includes detecting only a single-touch gesture that includes contact with a single point on the touchscreen.

According to yet another embodiment, a computer-readable medium stores instructions for processing user input on a computing device having one or more processors, a display device, and a multi-contact motion sensor interface configured to simultaneously detect contact at a plurality of points. When executed on the one or more processors, the instructions are configured to apply an image manipulation function to an image displayed on the display device in response to detecting a multi-contact gesture, in a multi-contact input mode. Further, the instructions are configured to transition from the multi-contact input mode to a single-contact input mode in response to detecting a single-contact mode activation sequence including one or more events. Still further, the instructions are configured to apply the image manipulation function to the image in response to detecting a single-contact gesture, in the second input mode.

### BRIEF DESCRIPTION OF THE DRAWINGS

FIG. 1 is a block diagram of an example device having a touchscreen for displaying output and receiving input, in which gesture processing techniques of the present disclosure can be implemented;

FIG. 2 is a block diagram of an example mapping system including a multimode gesture processing unit that can be implemented in the device of FIG. 1;

FIG. 3 is a diagram of a multi-touch gesture that invokes a zoom function, which the multimode gesture processing unit of FIG. 1 or FIG. 2 can support in one of the input modes;

FIG. 4 is a diagram of a multi-touch gesture that invokes a rotate function, which the multimode gesture processing unit of FIG. 1 or FIG. 2 can support in one of the input modes;

FIG. 5 is a diagram of a single-touch gesture that invokes a zoom function or a rotate function, which the multimode gesture processing unit of FIG. 1 or FIG. 2 can process in one of the input modes;

FIG. 6 is a diagram that illustrates selecting between a rotate function and a zoom function using initial movement in a single-touch gesture, which the multimode gesture processing unit of FIG. 1 or FIG. 2 can implement;

FIG. 7 is a state transition diagram of an example technique for processing gesture input in multiple input modes, which the multimode gesture processing unit of FIG. 1 or FIG. 2 can implement;

FIG. 8 is a timing diagram that illustrates processing a sequence of events, in an example implementation of the multimode gesture processing unit, to recognize a transition from a multi-touch gesture mode to a single-touch gesture mode and back to the multi-touch gesture mode;

FIG. 9 is a state transition diagram of an example technique for processing gesture input in a single-touch mode, which the multimode gesture processing unit of FIG. 1 or FIG. 2 can implement; and

FIG. 10 is a flow diagram of an example method for processing gesture input in multiple input modes, which the multimode gesture processing unit of FIG. 1 or FIG. 2 can implement.

### DETAILED DESCRIPTION

Using the techniques described below, a software application receives gesture input via a touchscreen in multiple input modes. In the first input mode, the software application processes multi-touch gestures involving simultaneous contact with multiple points on the touchscreen such as, for example, movement of fingers toward each other or away from each as input to a zoom function, or movement of one finger along a generally circular path relative to another finger as input to a rotate function. In second input mode, however, the software application processes single-touch gestures that involve contact with only one point on the touchscreen at a time. These single-touch gestures can serve as input to some of the same functions that the software application processes executes in accordance with multi-touch gestures in the first input mode. For example, the user can zoom in and out of an image by moving her thumb up and down, respectively, along the surface of the touchscreen. As another example, the user can move her thumb to the left to rotate the image clockwise and to the right to rotate the image counterclockwise.

To transition between the first input mode and the second input mode, the software application detects a mode transition event such as multi-touch or single-touch gesture, an increase in a surface area covered by a finger (in accordance with the so-called “fat finger” technique), a hardware key press or release, completion of input in the previously selected mode, etc. According to one example implementation, the user taps on the touchscreen and taps again in quick succession without lifting his finger off the touchscreen after the second tap. In response to this sequence of a first finger touchdown event, a finger liftoff event, and a second finger touchdown event, the software application transitions from the first, multi-touch input mode to the second, single-touch input mode. After the second finger touchdown event, the user moves the finger along a trajectory which the software application interprets as input in the second input mode. The software application then automatically transitions from the second input mode back to the first input mode when the second liftoff event occurs, i.e., when the user lifts his finger off the touchscreen.

Processing user input according to multiple input modes may be useful in a variety of situations. As one example, a user may prefer to normally hold a smartphone in one hand while manipulating objects on the touchscreen with the other hand using multi-touch gestures. However, the same user may find it inconvenient to use the smartphone in this manner when she is holding on to a handle bar or handle ring on the subway, or in other situations when only one of her hands is free. When an electronic device implements the techniques of this disclosure, the user may easily switch to the single-touch mode and continue operating the smartphone.

Processing user input in accordance with multiple input modes is discussed in more detail below with reference to portable touchscreen devices that execute applications that provide interactive digital two- and three-dimensional maps. Moreover, the discussion below focuses primarily on two map manipulation functions, zoom and rotate. It will be noted, however, that the techniques of this disclosure also can be applied to other map manipulation functions such as three-dimensional tilt, for example. Further, these techniques also may be used in a variety of applications such as web browsers, image viewing and editing applications, games, social networking applications, etc. Thus, instead of invoking map manipulation functions in multiple input modes as discussed below, non-mapping applications can invoke other image manipulation functions. Still further, that although processing gesture input is discussed below with reference to devices equipped with a touchscreen, it will be noted that these or similar techniques can be applied to any suitable motion sensor interface, including a three-dimensional gesture interface. Accordingly, although the examples below for simplicity focus on single-touch and multi-touch gestures, suitable gestures may be other types of single-contact and multi-contact gestures, in other implementations of the motion sensor interface.

Also, it will be noted that single-contact gestures need not always be used in conjunction with multi-contact gestures. For example, a software application may operate in two or more single-contact modes. Further, in some implementations, gestures in different modes may be mapped to different, rather than same, functions.

In addition to allowing users to manipulate images such as digital maps or photographs, devices can implement the techniques of the present disclosure to receive other input and invoke other functions. For example, devices may apply these gesture processing techniques to text (e.g., in text editing applications or web browsing applications), icons (e.g., in user interface functions of an operating system), and other displayed objects. More generally, the gesture processing techniques of the present disclosure can be used in any system configured to receive user input.

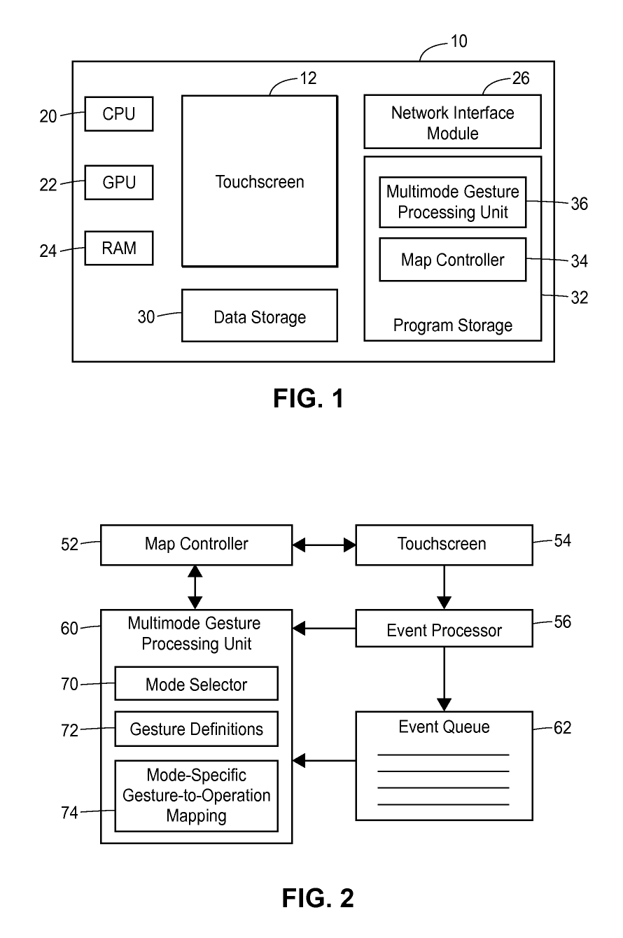

Referring to FIG. 1, a device 10 in an example embodiment includes a touchscreen 12 via which a user may provide gesture input to the device 10 using fingers or stylus. The device 10 may be a portable device such as a smartphone, a personal digital assistant (PDA), a tablet computer, a laptop computer, a handheld game console, etc., or a non-portable computing device such as a desktop computer. The device 10 includes a processor (or a set of two or more processors) such as a central processing unit (CPU) 20 that execute software instructions during operation. The device 10 also may include a graphics processing unit (GPU) 22 dedicated to rendering images to be displayed on the touchscreen 12. Further, the device 10 may include a random access memory (RAM) unit 24 for storing data and instructions during operation of the device 10. Still further, the device 10 may include a network interface module 26 for wired and/or wireless communications.

In various implementations, the network interface module 26 may include one or several antennas and an interface component for communicating on a 2G, 3G, or 4G mobile communication network. Alternatively or additionally, the network interface module 26 may include a component for operating on an IEEE 802.11 network. The network interface module 26 may support one or several communication protocols, depending on the implementation. For example, the network interface 26 may support messaging according to such communication protocols as Internet Protocol (IP), Transmission Control Protocol (TCP), User Datagram Protocol (UDP), Secure Socket Layer (SSL), Hypertext Transfer Protocol (HTTP), etc. The network interface 26 in some implementations is a component of the operating system of the device 10.

In addition to the RAM unit 24, the device 10 may include persistent memory modules such as a data storage 30 and a program storage 32 to store data and software instructions, respectively. In an example implementation, the components 30 and 32 include non-transitory, tangible computer-readable memory such as a hard disk drive or a flash chip. The program storage 32 may store a map controller 34 that executes on the CPU 20 to retrieve map data from a map server (not shown) via the network interface module 26, generate raster images of a digital map using the map data, process user commands for manipulating the digital map, etc. The map controller 34 may receive user commands from the touchscreen 12 via a gesture processor such as a multimode gesture processing unit 36. Similar to the map controller 34, the multimode gesture processing unit 36 may be stored in the program storage 32 as a set of instructions executable on the CPU 20.

As an alternative, however, the device 10 may be implemented as a so-called thin client that depends on another computing device for certain computing and/or storage functions. For example, in one such implementation, the device 10 includes only volatile memory components such as the RAM 24, and the components 30 and 32 are external to the client device 10. As yet another alternative, the map controller 34 and the multimode gesture processing unit 36 can be stored only in the RAM 24 during operation of the device 10, and not stored in the program storage 32 at all. For example, the map controller 34 and the multimode gesture processing unit 36 can be provided to the device 10 from the Internet cloud in accordance with the Software-as-a-Service (SaaS) model. The map controller 34 and/or the multimode gesture processing unit 36 in one such implementation are provided in a browser application (not shown) executing on the device 10.

In operation, the multimode gesture processing unit 36 processes single- and multi-touch gestures using the techniques of the present disclosure. More particularly, an operating system or another component of the device 10 may generate touchscreen events in response to the user placing his or her fingers on the touchscreen 12. The events may be generated in response to a detected change in the interaction between one or two fingers and a touchscreen (e.g., new position of a finger relative to the preceding event) or upon expiration of a certain amount of time since the reporting of the preceding event (e.g., ten milliseconds), depending on the operating system and/or configuration. Thus, touchscreen events in some embodiments of the device 10 are always different from the preceding events, while in other embodiments, consecutive touchscreen events may include identical information.

The map controller 34 during operation receives map data in a raster or non-raster (e.g., vector graphics) format, process the map data, and generates a digital map to be rendered on a touchscreen. The map controller 34 in some cases uses a graphics library such as OpenGL, for example, to efficiently generate digital maps. Graphics functions in turn may utilize the GPU 22 as well as the CPU 20. In addition to interpreting map data and generating a digital map, the map controller 34 supports map manipulation functions for changing the appearance of the digital map in response to multi-touch and single-touch gestures detected by the map controller 34. For example, the user may use gestures to select a region on the digital map, enlarge the selected region, rotate the digital map, tilt the digital map in the three-dimensional mode, etc.

Next, FIG. 2 illustrates an example mapping system in which a multimode gesture processing unit 60 may process gesture input in multiple input modes. In addition to the multimode gesture processing unit 60, the system of FIG. 2 includes a map controller 52, a touchscreen 54, an event processor 56, and an event queue 62. The system of FIG. 2 may be implemented in the device 10 discussed above, for example (in which case the multimode gesture processing unit 60 may be similar to the multimode gesture processing unit 36, the map controller 52 may be similar to the map controller 34, and the touchscreen 54 may be similar to the touchscreen 12). In one embodiment, the illustrated components of the map rendering module 50 are implemented as respective software modules operating on a suitable platform such as the Android™ operating system, for example.

The event processor 56 may be provided as a component of an operating system or as a component of an application that executes on the operating system. In an example implementation, the event processor 56 is provided as a shared library, such as a dynamic-link library (DLL), with functions for event processing that various software applications can invoke. The event processor 56 generates descriptions of touchscreen events for use by the multimode gesture processing unit 60. Each touchscreen event may be characterized by two-dimensional coordinates of each location on the surface of the touchscreen where a contact with a finger is detected, which may be referred to as a “point of contact.” By analyzing a sequence of touchscreen events, the trajectory of a finger (or a stylus) on the touchscreen may be determined. Depending on the implementation, when two or more fingers are on the touchscreen, a separate touchscreen event may be generated for each point of contact, or, alternatively, a single event that describes all points of contact may be generated. Further, in addition to the coordinates of one or points of contact, a touchscreen event in some computing environments also may be associated with additional information such as motion and/or transition data. If the device 10 runs the Android operating system, the event processor 56 may operate on instances of the MotionEvent class provided by the operating system.

The event processor 56 may store descriptions of touchscreen events in the event queue 62, and the multimode gesture processing unit 60 may process these descriptions to identify gestures. In an embodiment, the number of event descriptions stored in the event queue 62 is limited to M touchscreen events. The multimode gesture processing unit 60 may also require a minimum number L of event descriptions to trigger an analysis of the events. Thus, although the event queue 62 at some point may store more than M or less than L event descriptions, the multimode gesture processing unit 60 may operate on N events, where L≦N≦M. Further, the multimode gesture processing unit 60 may require that the N events belong to the same event window W of a predetermined duration (e.g., 250 ms).

With continued reference to FIG. 2, the multimode gesture processing unit 60 includes a mode selector 70, a gesture definitions module 72, and a mode-specific gesture-to-operation (or function) mapping module 74. The gesture definitions module 72 may store a definition of a gesture G in the form of set S_{G} of start conditions C₁, C₂, . . . C_{N}, for example, so that gesture G starts only when each of the condition in the set S_{G} is satisfied. The number of conditions for starting a particular gesture may vary according to the complexity of the gesture. As one example, a relatively simple two-finger tap gesture may include a small number of conditions such as detecting contact with the touchscreen at two points within a certain (typically very small) time interval, determining that the distance between the two points of contact is greater than a certain minimum value, and determining that the duration of the contact at each point does not exceed a certain maximum value. As another example, a more complex two-finger scale gesture may include numerous conditions such as determining that the distance between two points of contact changes at or above a certain predefined rate, determining that the initial distance between the two points of contact exceeds a certain minimum value, determining that the two points of contact remain on the same line (with a certain predefined margin of error), etc. The multimode gesture processing unit 60 may compare descriptions of individual touchscreen events or sequences of touchscreen events with these sets of start to identify gestures being performed.

Further, when a certain sequence of touchscreen events is detected or another predefined event occurs, a mode selector 70 switches between a multi-touch mode and a single-touch mode. In the multi-touch mode, the multimode gesture processing unit 60 recognizes and forwards to the map controller 52 multi-touch gestures as well as single-touch gestures. In the single-touch mode, the multimode gesture processing unit 60 recognizes only single-touch gestures. The mode-specific gesture-to-operation mapping module 74 stores mapping of gestures to various functions supported by the map controller 52. A single map manipulation function may be mapped to multiple gestures. For example, the zoom function can be mapped to a certain two-finger gesture in the multi-touch input mode and to a certain single-finger gesture in the single-finger mode. The mapping in some implementations may be user-configurable.

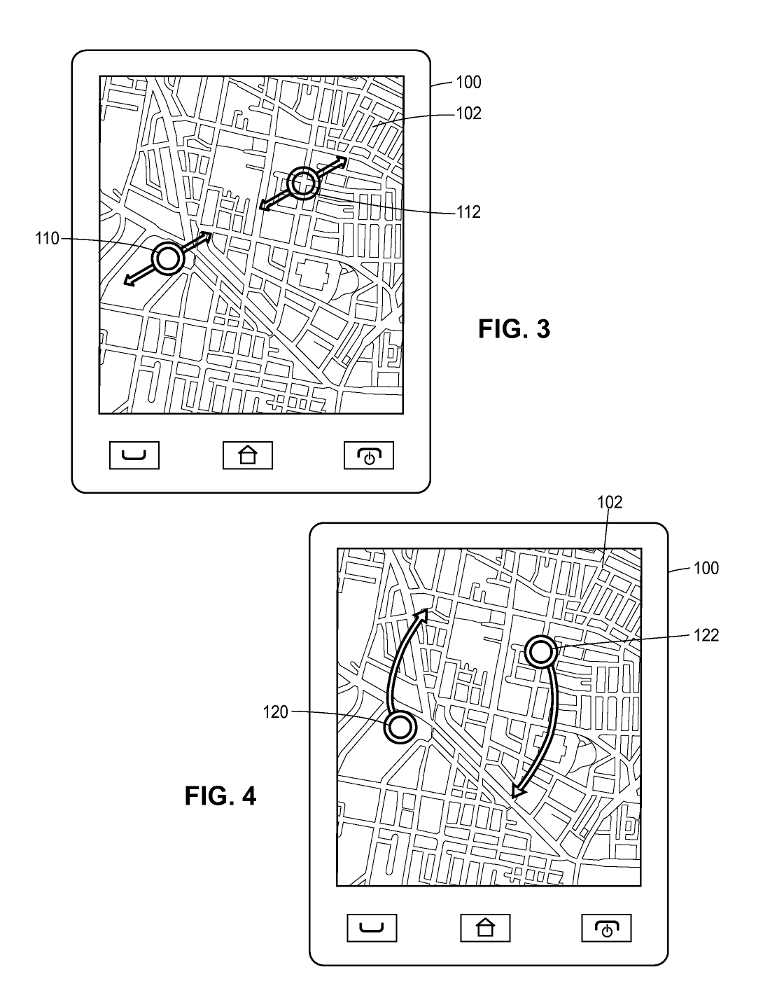

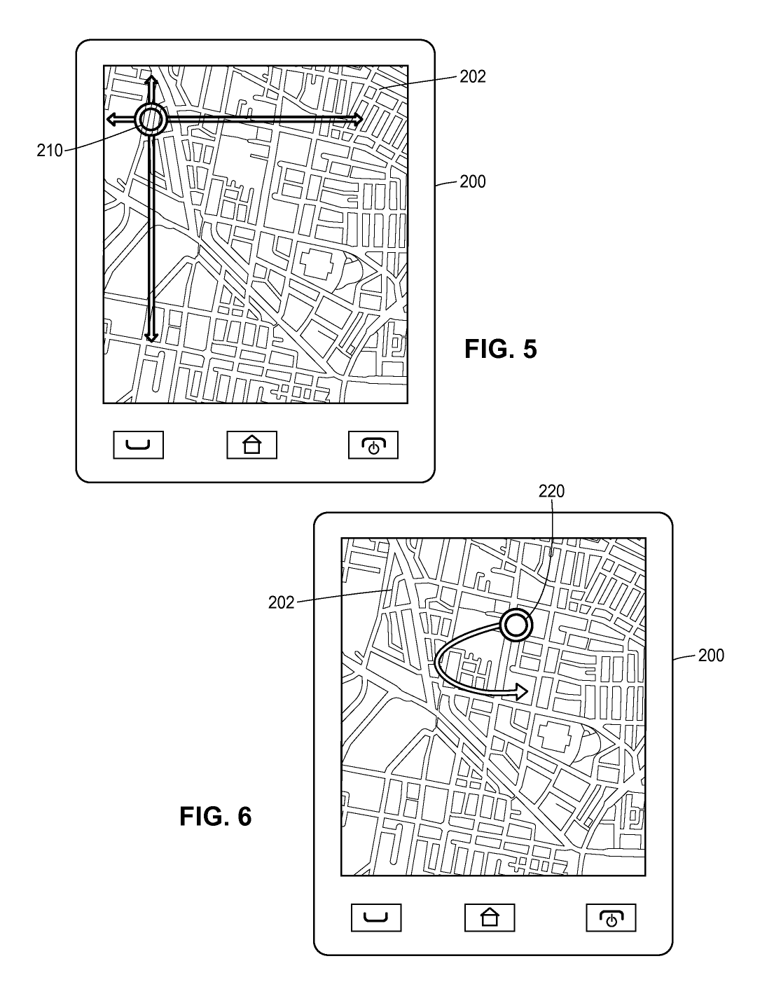

Next, to better illustrate example operation of the multimode gesture processing unit 36 or 60, multi-touch gestures that can be used to invoke a zoom function and a rotate function are discussed with reference to FIGS. 3 and 4, respectively. Single-touch gestures that can be used to invoke these map manipulation functions are discussed with reference to FIG. 5, and selection of a map manipulation function from among several available functions, based on the initial movement of a point of contact, is discussed with reference to FIG. 6. The mode-specific gesture-to-operation mapping module 74 may recognize the corresponding gesture-to-function mapping for each gesture of FIGS. 3-5, and the map controller 52 then can modify the digital map in accordance with the gestures of FIGS. 3 and 4 in the multi-touch input mode and modify the digital map in accordance with one of the gestures of FIG. 5 in the single-touch input mode.

FIG. 3 illustrates zooming in and out of a digital map 102 on an example touchscreen device 100 using a multi-touch (in this case, two-finger) gesture. In particular, moving points of contact 110 and 112 away from each other results in zooming out of the area currently being displayed, and moving the points of contact 110 and 112 toward each other results in zooming in on the area currently being displayed.

FIG. 4 illustrates rotating the map 102 on the device 100 using another two-finger gesture. In this scenario, moving points of contact 120 and 122 along a circular trajectory relative to each other results in rotating the digital map 102.

Now referring to FIG. 5, a user can zoom in and out of a digital map 202 displayed on a touchscreen device 200 using a single-touch (in this case, one-finger) gesture. According to an example embodiment, (i) moving a point of contact 210 upward results in increasing the zoom level at which the digital map 202 is displayed in proportion with the distance travelled by the point of contact 210 relative to its initial position, (ii) moving the point of contact 210 down results in decreasing the zoom level in proportion with the distance travelled by the point of contact 210 relative to its initial position, (iii) moving the point of contact 210 to the left results in rotating the digital map 202 clockwise, and (iv) moving the point of contact 210 to the right results in rotating the digital map 202 counterclockwise. If, for example, the initial position of the point of contact 210 is in the upper left corner, a wider range of motion is available for the downward motion than for the upward motion and for the rightward motion than for the leftward motion. The extent to which the digital map 202 can be zoomed out is greater than the extent to which the digital map 202 can be zoomed into. Similarly, the extent to which the digital map 202 can be rotated counterclockwise is greater than the extent to which the digital map 202 can be rotated clockwise. Thus, the initial position of the point of contact can effectively define the range of input to the rotate or zoom function, according to this implementation. In an alternative implementation, however, the range of available motion in each direction can be normalized so as to enable the user to change the zoom level of, or rotate, the digital map 210 equally in each direction (albeit at different rates).

FIG. 6 illustrates selecting between a rotate function and a zoom function according to an example implementation. Because a user cannot always move his finger only vertically or only horizontally, the trajectory of a point of contact typically includes both a vertical and a horizontal component. In FIG. 6, a point of contact 220 initially moves mostly to the left but also slightly downward. To select between the zoom gesture and the rotate gesture, the multimode gesture processing unit 36 or 60 (or another module in other implementations) may determine which of the horizontal and vertical movements is more dominant at the beginning of the trajectory of the point of contact 220. In the example of FIG. 6, the rotate function may be selected.

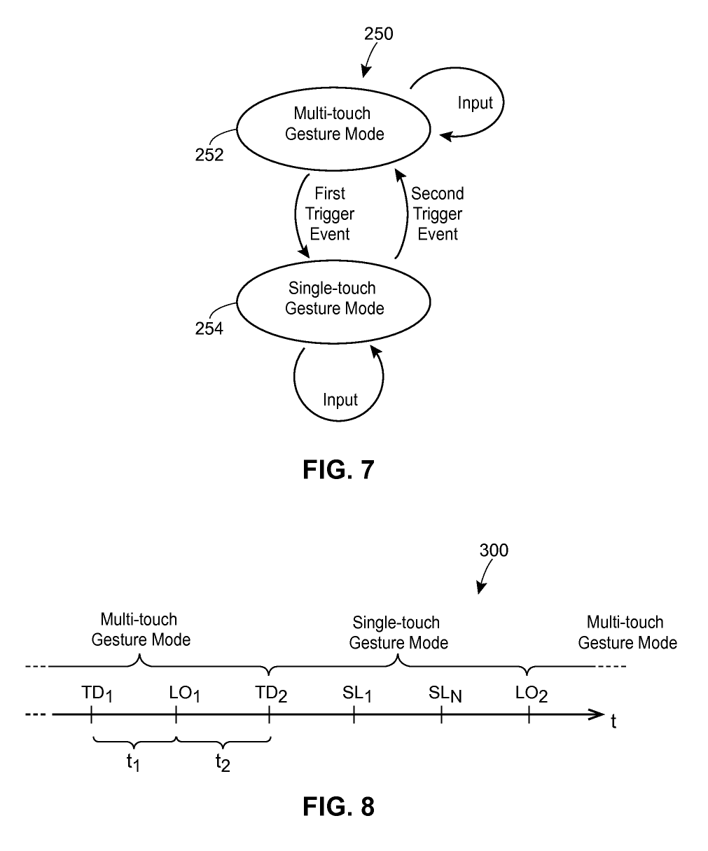

For further clarity, FIGS. 7-10 illustrate several techniques for processing gesture input in multiple input modes. These techniques can be implemented in the multimode gesture processing unit 36 of FIG. 1 or the multimode gesture processing unit 60 of FIG. 2, for example, using firmware, software instructions in any suitable language, various data structures, etc. More generally, these techniques can be implemented in any suitable software application.

First, FIG. 7 illustrates a state transition diagram of an example state machine 250 for processing gesture input in two input modes. The state machine 250 includes state 252 in which the software application can receive multi-touch gestures (as well as single-touch gestures) and state 254 in which the software application can receive only single-touch gestures. The transition from state 252 to state 254 occurs in response to a first trigger event, which may be a particular sequence of touchscreen events, for example. The transition from state 254 to state 252 occurs in response to a second trigger event, which may be completion of a single-touch gesture, for example. In this example, state 252 may be regarded as the “normal” state because input other than the first trigger event is processed in state 252. This input can include, without limitation, multi-touch gestures, single-touch gestures, hardware key press events, audio input, etc. In other words, the software application temporarily transitions to state 254 to process a single-touch gesture under particular circumstances and then returns to state 252 in which the software application generally receives input.

Further regarding the first trigger event, FIG. 8 is a timing diagram 300 that illustrates processing an example sequence of touchscreen events to recognize a transition from a multi-touch gesture mode to a single-touch gesture mode and back to the multi-touch gesture mode. While in a multi-touch gesture mode, the multimode gesture processing unit 36 or 60 or another suitable module detects a first finger touchdown event TD₁ quickly followed by a first finger liftoff event LO₁ More specifically, the events TD₁ and LO₁ may be separated by time t₁<T₁, where T₁ is a time limit for detecting a single tap gesture.

After time t₂<T₂, where T₂ is a time limits for detecting a double tap gesture, the multimode gesture processing unit 36 or 60 detects a second finger touchdown event TD₂. In response to detecting the sequence TD₁, LO₁, and TD₂, the multimode gesture processing unit 36 or 60 transitions to the single-touch gesture module. In this state, the multimode gesture processing unit 36 or 60 receives touchscreen slide events SL₁, SL₂, SL_{N}, for example. In other implementations, the multimode gesture processing unit 36 or 60 can receive other indications of movement of a finger along a touchscreen surface, such as events that report a new position of the finger at certain times. Upon detecting a second finger liftoff event LO₁, the multimode gesture processing unit 36 or 60 transitions back to the multi-touch gesture mode.

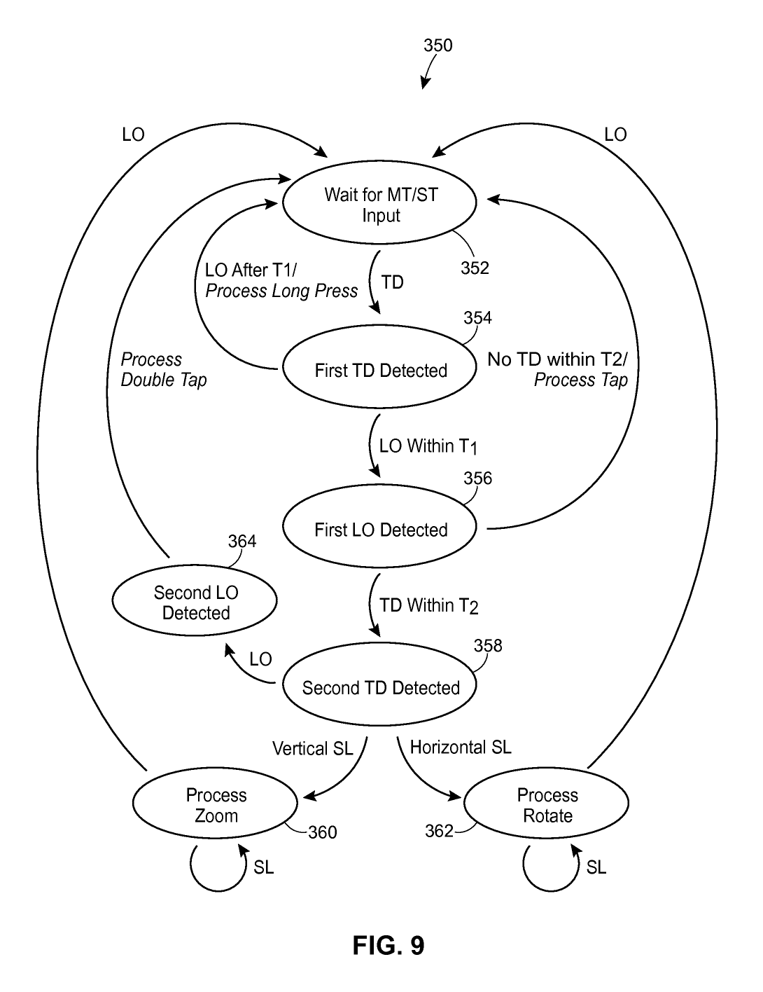

Next, FIG. 9 illustrates a more detailed state transition diagram of an example state machine 350 for receiving user input in two input modes. In FIG. 9, some of the state transitions list triggering events as well as actions taken upon transition (in italics).

In state 352, a software application receives various multi-touch and single-touch input. This input may include multiple instances of multi-finger gestures and single-finger gestures. After a touchdown event at a point of contact is detected, the software application transitions to state 354 in which the software application awaits a liftoff event. If the liftoff event occurs within time interval T₁, the software application advances to state 356. Otherwise, if the liftoff event occurs outside time interval T₁, the software application processes a long press event and returns to state 352.

At state 356, the software application recognizes a tap gesture. If the state machine 350 does not detect another touchdown event within time interval T₂, the software application processes the tap gesture and returns to state 352. If, however, a second touchdown event is detected within time interval T₂, the software application advances to state 358. If the second touchdown event is followed by a liftoff event, the state machine 350 transitions to state 364. For simplicity, FIG. 9 illustrates unconditional transition from state 364 to state 352 and processing a double tap gesture during this transition. It will be noted, however, that it is also possible to await other touchscreen events in state 364 to process a triple tap or some other gesture.

If a vertical, or mostly vertical, initial movement (or “sliding”) of the point of contact is detected in state 358, the zoom function is activates and the software application advances to state 360. In this state, sliding of the point of contact is interpreted as input to the zoom function. In particular, upward sliding may be interpreted as a zoom-in command and downward sliding may be interpreted as a zoom-out command. On the other hand, if a horizontal, or mostly horizontal, initial sliding of the point of contact is detected in state 358, the software application activates the rotate function and advances to state 362. In state 362, sliding of the point of contact is interpreted as input to the rotate function. Then, once a liftoff event is detected in state 360 or 362, the software application returns to state 352.

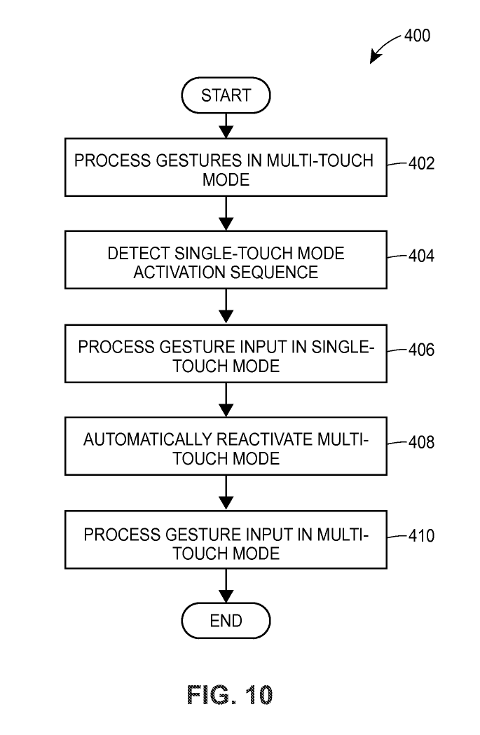

Now referring to FIG. 10, an example method for processing gesture input in multiple input modes may be implemented in the multimode gesture processing unit 36 or 60, for example. At block 402, gestures are processed in a multi-touch mode. A software application may, for example, invoke function F₁ in response to a multi-touch gesture G₁ and invoke function F₂ in response to a multi-touch gesture G₂. A single-touch mode activation sequence, such as the {TD₁, LO₁, TD₂} sequence discussed above, is detected at block 404. Gesture input is then processed in a single-touch mode in block 406. In this mode, the same function F₁ now may be invoked in response to a single-touch gesture G′₁ and the same function F₂ may be invoked in response to a single-touch gesture G′₂.

The multi-touch mode is automatically reactivated at block 408 upon completion of input in the single-touch mode, for example. At block 410, gesture input is processed in multi-touch mode.

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Upon reading this disclosure, those of skill in the art will appreciate still additional alternative structural and functional designs for processing gesture input in multiple input modes through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A method for processing user input on a computing device having a display device and a motion sensor interface, the method comprising:
providing an interactive digital map via the display device;
processing input received via the motion sensor interface in a first input mode, including invoking a map manipulation function in response to detecting an instance of a multi-contact gesture, including selecting the map manipulation function from among a plurality of map manipulation functions;
detecting a mode transition event; and
subsequently to detecting the mode transition event, processing input received via the motion sensor interface in a second input mode, including invoking the same map manipulation function in response to detecting instance of a single-contact gesture, including selecting the same map manipulation function from among the plurality of map manipulation functions, each being mapped to a respective multi-contact gesture and a respective single-contact gesture.

2. The method of claim 1, wherein:
invoking the map manipulation functions in response to the multi-contact gesture includes measuring movement of at least a first point of contact relative to a second point of contact, and
invoking the map manipulation function in response to the single-contact gesture includes measuring movement of exactly one point of contact;
wherein the measured movement is provided to the map manipulation function as a parameter.

3. The method of claim 2, wherein the plurality of map manipulation functions includes (i) a zoom function and (ii) a rotate function.

4. The method of claim 3, wherein measuring movement of the point of contact in the second input mode includes measuring (i) a direction of the movement and (ii) a distance travelled by the point of contact, and wherein:
when the manipulation is the zoom function, the direction of movement determines whether a current zoom level is increased or decreased, and the distance travelled by the point of contact determines an extent of a change of the current zoom level, and
when the manipulation is the rotate function, the direction of movement determines whether a current orientation of the digital map is changed clockwise or counterclockwise, and the distance travelled by the point of contact determines an extent of rotation.

5. The method of claim 3, further comprising selecting between the zoom function and the rotate function in the second input mode based on an initial direction of the movement of the point of contact.

6. The method of claim 1, wherein the display device and the motion sensor interface are components of a touchscreen.

7. The method of claim 6, wherein the mode transition event consists of a first touchdown event, a liftoff event, and a second touchdown event.

8. The method of claim 7, wherein the single-contact gesture includes movement of a finger along a surface of the touchscreen immediately after the second touchdown event without an intervening liftoff event.

9. The method of claim 1, further comprising automatically transitioning to the first input mode upon completion of the single-contact gesture.

10. The method of claim 1, wherein the mode transition event is generated in response to a user actuating a hardware key.

11. A method for processing user input on a computing device having a touchscreen, the method comprising:
providing an interactive digital map via the touch screen;
processing input in a multi-touch mode, including:
detecting a multi-touch gesture that includes simultaneous contact with multiple points on the touchscreen,
selecting, from among a plurality of map manipulation functions, a manipulation function corresponding to the detected multi-touch gesture, and
executing the selected map manipulation function;
detecting a single-touch mode activation sequence including one or more touchscreen events;
subsequently to detecting the single-touch mode activation sequence, processing input in a single-touch mode, including:
detecting only a single-touch gesture that includes contact with a single point on the touchscreen,
selecting, from among the plurality of map manipulation functions, the same manipulation function corresponding to the detected single-touch gesture, and
executing the selected map manipulation function; and
automatically reverting to the multi-touch mode upon the processing of input in the single-touch mode.

12. (canceled)

13. The method of claim 11, wherein the selected map manipulation function is a zoom function, and wherein invoking the zoom function includes:
measuring (i) a direction of movement of the point of contact with the touchscreen and (ii) a distance travelled by the point of contact with the touchscreen,
determining whether a current zoom level is increased or decreased based on the measured direction of movement, and
determining an extent of a change of the current zoom level based on the measured distance.

14. The method of claim 11, wherein the selected map manipulation function is a rotate function, and wherein invoking the rotate function includes:
measuring (i) a direction of movement of the point of contact with the touchscreen and (ii) a distance travelled by the point of contact with the touchscreen,
determining a current orientation of the digital map based on the measured direction of movement, and
determining an extent of rotation based on the measured distance.

15. The method of claim 11, wherein processing input in the single-touch mode includes:
determining an initial direction of movement of the point of contact with the touchscreen,
selecting one of a zoom function and a rotate function based on the determined initial direction of movement, and
applying the selected one of the zoom function and the rotate function to the digital map.

16. The method of claim 11, wherein the single-touch mode activation sequence includes a first touchdown event, a liftoff event, and a second touchdown event.

17. A non-transitory computer-readable medium storing thereon instructions for processing user input on a computing device having one or more processors, a display device, and a multi-contact motion sensor interface configured to simultaneously detect contact at a plurality of points, and wherein the instructions, when executed on the one or more processors, are configured to:
provide an interactive digital map via the display device;
in a multi-contact input mode, apply a map manipulation function to the digital map in response to detecting a multi-contact gesture, the map manipulation function selected from among a plurality of map manipulation functions;
transition from the multi-contact input mode to a single-contact input mode in response to detecting a single-contact mode activation sequence including one or more events;
in the second input mode, apply the same map manipulation function to the digital map in response to detecting a single-contact gesture, wherein each of the plurality of map manipulation functions is mapped to a respective multi-contact gesture and a respective single-contact gesture.

18. The computer-readable medium of claim 17, wherein map manipulation function is a zoom function.

19. The computer-readable medium of claim 17, wherein map manipulation function is a rotate function.

20. The computer-readable medium of claim 17, wherein the display device and the motion sensor interface are components of a touchscreen.

21. The computer-readable medium of claim 20, wherein the single-contact mode activation sequence includes a first touchdown event, a liftoff event, and a second touchdown event.

22. The computer-readable medium of claim 21, wherein the liftoff event is a first liftoff event, and wherein the instructions are further configured to transition from the single-contact input mode to a multi-contact input mode in response to a second liftoff event.
